(19) United States
(12) Patent Application Publication
(10) Pub. No.: US 2026/0121928 A1
(43) Pub. Date: Apr. 30, 2026

(54) CROSS DOMAIN POLICY WITH INTENT-BASED CATALOG(S) IN NETWORK(S)

(71) Applicant: Cisco Technology, Inc., San Jose, CA (US)

(72) Inventors: Balaji Sundararajan, Fremont, CA (US); Sanjay Kumar Hooda, Pleasanton, CA (US); Ankur Bhargava, Pleasanton, CA (US); Vivek Agarwal, Campbell, CA (US); Venkatesh Gota B R, Bangalore (IN); Sanjeev Pandurang Tondale, Fremont, CA (US)

(21) Appl. No.: 18/932,905

(22) Filed: Oct. 31, 2024

(51) Int. Cl. H04L 41/0894; H04L 41/12

(52) U.S. Cl. CPC H04L 41/0894; H04L 41/12

(57) ABSTRACT

This disclosure describes techniques and mechanisms for enabling streamlined and simplified cross domain routing policies within an enterprise networks. The techniques include receiving an intent of a user and, based on the intent, automatically determining a network topology and automatically generating a global policy, that includes policy definitions for domains (e.g., LAN, WAN, etc.) that take into account the various needs of LAN and WANs. The global policy may be deployed for enforcement within each domain and device of the network, ensuring consistent user experience and harmonious enforcement. The techniques may also generate catalogs of pre-defined global policies for particular industries. Users may customize and/or deploy the catalog(s) with minimal input, streamlining and simplifying cross domain routing in enterprise networks.

### TECHNICAL FIELD

The present disclosure relates generally to the field of computer networking, and more particularly to for enabling consistent policy enforcement across domains in enterprise networks.

### BACKGROUND

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of networks, such as Local-Area Networks (LANs) that are in one physical location such as a building, Wide-Area Networks (WANs) that extend over a large geographic area to connect individual users or LANs, Enterprise Networks that are built for a large organization, Internet Service Provider (ISP) Networks that operate WANs to provide connectivity to individual users or enterprises, software-defined networks (SDNs), wireless networks, core networks, cloud networks, and so forth.

These networks often include specialized network devices to communicate packets representing various data from device-to-device, such as switches, routers, servers, access points, and so forth. Each of these devices is designed and configured to perform different networking functions. For instance, switches act as controllers that allow devices in a network to communicate with each other. Routers connect multiple networks together, and also connect computers on those networks to the Internet, by acting as a dispatcher in networks by analyzing data being sent across a network and choosing an optimal route for the data to travel. Access points act like amplifiers for a network and serve to extend the bandwidth provided by routers so that the network can support many devices located further distances from each other.

One example network is an enterprise network that utilizes a software-defined wide area network (SD-WAN). The SD-WAN may support multiple domains within the enterprise network, such as LAN, WAN, datacenters, wireless, etc. Current techniques for defining routing and access policies in enterprise networks include an administrator defining policies manually within each of the domains (e.g., LAN, WAN, etc.).

Under current techniques, controllers within each domain perform policy enforcement of the access and routing policies on the network devices within each respective domain. However, context of the policies in one domain (e.g., such as LAN) is not shared with the other domains in the enterprise network, resulting in the policies not being enforced uniformly across the different domains of the enterprise networks. Thus, current techniques for implementing policies in cross-domain enterprise networks fail to provide consistent policy enforcement, such that domains (LAN, WAN, wireless, etc.) may not be resilient to network failures.

Accordingly, there is a need to provide a centralized common policy that can be shared across domains of an enterprise network.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a system can generate and provide catalog(s) and global policies for enterprise networks.

FIG. 2 illustrates a component diagram of an example entity, as described in FIG. 1.

FIG. 3 an example environment showing how a global policy may be enforced end-to-end in an industry network, according to the techniques described in FIGS. 1-2.

FIG. 4 illustrates a flow diagram of an example system for automatically generating a global policy based on a network intent, in accordance with the techniques described in FIGS. 1-3.

FIG. 5 a flow diagram of an example system for generating and providing catalog(s) of global policies based on industry verticals, in accordance with the techniques described in FIGS. 1-4.

FIG. 6. is a computer architecture diagram showing an illustrative computer hardware architecture for implementing a device that can be utilized to implement aspects of the various technologies presented herein.

### DESCRIPTION OF EXAMPLE EMBODIMENTS

### Overview

The present disclosure relates generally to the field of computer networking, and more particularly to enabling consistent policy enforcement across domains in enterprise networks.

A method for enabling consistent policy enforcement across domains in enterprise networks is described herein. The method may include receiving, by a central entity and from a computing device of a user, an input comprising a network intent of a network. The method may include determining, by the central entity and in response to the network intent, a structure of the network, the structure including one or more domains. The method may include generating, by the central entity and based on the network intent and the structure, one or more sets of end-to-end routing policies for each respective domain of the one or more domains. The method may include sending the one or more sets of end-to-end routing policies to one or more network devices of the network to enable the one or more network devices to implement cross-domain routing according to the network intent.

Another method may include generating, for one or more vertical constructs of one or more industry topologies, one or more catalogs including respective sets of pre-defined global routing policy definitions. The method may include storing, in memory associated with an entity, respective catalogs in association with respective industry topologies. The method may include receiving an input associated with a user, the input including an indication of a first industry and providing, based on the first industry, a first catalog comprising first sets of pre-defined global routing policy definitions.

Additionally, any techniques described herein, may be performed by a system and/or device having non-transitory computer-readable media storing computer-executable instructions that, when executed by one or more processors, performs the method(s) described above and/or one or more non-transitory computer-readable media storing computer-readable instructions that, when executed by one or more processors, cause the one or more processors to perform the method(s) described herein.

### Example Embodiments

As noted above, an example network may include an enterprise network that utilizes a software defined wide area network (SD-WAN). The SD-WAN may support multiple domains within the enterprise network, such as LAN, WAN, datacenters, wireless, etc.

Current techniques for defining routing and access policies in enterprise networks include an administrator defining policies manually within each of the domains (e.g., LAN, WAN, etc.). Under current techniques, controllers within each domain perform policy enforcement of the access and routing policies on the network devices within each respective domain. However, context of the policies in one domain (e.g., such as LAN) is not shared with the other domains in the enterprise network, resulting in the policies not being enforced uniformly across the different domains of the enterprise networks. Thus, current techniques for implementing policies in cross-domain enterprise networks fail to provide consistent policy enforcement, such that domains (LAN, WAN, wireless, etc.) may not be resilient to network failures.

For instance, current techniques allow an administrator to access each domain within an enterprise network and define control policies for the particular domain (e.g., WAN, LAN, Campus, SaaS, etc.). When traffic is being moved across the particular domain, a controller within the domain performs policy enforcement. However, interfaces in different domains are currently mapped into different segments. Accordingly, traffic moving between different domains may not enforce policies in a harmonious manner or in similar ways. For instance, constructs from domains such as nexus, sonic, cloud databases may get mapped to cloud segments; AWS has cloud segments from VLANs that can be mapped into different segment IDs. Further, this individualized segmentation occurs prior to the traffic routing from a first domain to a second domain and are performed as separate automations. As noted above, context associated with a particular policy in the first domain is not shared between controllers of the different domains. This results in policy being applied differently in the first domain versus the second domain, resulting in quality-of-service (QoS) issues and potential security vulnerabilities to the network.

Accordingly, there is a need to provide a centralized common policy that can be shared across domains of an enterprise network.

This disclosure describes systems and mechanisms for enabling consistent policy enforcement across domains in enterprise networks using a global policy. In some examples, the system may receive, by a central entity and from a computing device of a user, an input comprising a network intent of a network. The system may determine, by the central entity and in response to the network intent, a structure of the network, the structure including one or more domains. The system may generate, by the central entity and based on the network intent and the structure, one or more sets of end-to-end routing policies for each respective domain of the one or more domains. Additionally, the system may send the one or more sets of end-to-end routing policies to one or more network devices of the network to enable the one or more network devices to implement cross-domain routing according to the network intent.

This disclosure also describes systems and mechanisms for enabling consistent policy enforcement across domains in enterprise networks using catalogs. In some examples, the system may generate, for one or more vertical constructs of one or more industry topologies, one or more catalogs including respective sets of pre-defined global routing policy definitions. The system may store, in memory associated with an entity, respective catalogs in association with respective industry topologies. The system may receive an input associated with a user, the input including an indication of a first industry. They system may also provide, based on the first industry, a first catalog comprising first sets of pre-defined global routing policy definitions for display.

In some examples, the system may include an entity, such as a centralized or global entity. The entity may correspond to Cisco's Global Manager feature. The entity may include a global controller. In some examples, the global controller may include a policy module. In some examples, the policy module may be configured to generate global policies that include context that can be shared across domains within an enterprise network. For instance, the policy module may determine that an input is received from an administrator device, the input indicating a network intent. The network intent may specify at a high-level particular user groups, types of data, priority of the data, etc. Based on the network intent, the policy module may automatically determine a topology (type(s) of domains, number, types, and features of network device(s), etc.) of the enterprise network of the administrator. The system may, based on the network, generate policy definitions for each of the domains based on the network intent as part of a global policy. For instance, the global policy may include policy definitions for how network device(s) (e.g., switches, access points, routers, etc.) within each domain are to handle traffic according to the network intent. The global policy may be sent to the network devices for implementation and enforcement automatically or based on input approving the policy definitions received from the administrator. Thus, by implementing the global policy at the network devices and in contrast to existing techniques that perform each mapping as a separate automation, the system described herein expresses the network intent for cross domain workflow between domains (e.g., a campus, WAN, LAN, etc.), thereby enabling the system to stitch end-to-end workflows.

In some examples, the policy module may generate the global policy based on determining the network intent is associated with a pre-defined industry vertical topology. In this example, the policy module may automatically generate policies for wireless, SD-LAN, SD-WAN, etc., while taking into account the LAN and WAN needs. For instance, the policy module may generate SLA requirements for WAN, Nat Dia policies, Data and Control Policies for WANs, while also creating a BGP EVPN configuration policy for a CAMPUS LAN, and creating a pre-defined virtual LAN (VLAN), VRF, and QoS policy for integrating LAN traffic and Wireless controllers and access points in the enterprise network.

In some examples, the policy module may integrate the network intent as context included in the global policy. For instance, the context may be associated with a group tag (e.g., such as a security group tag or other group construct). For instance, a group tag may be associated with a particular domain type (e.g., such as a datacenter, SaaS Cloud, internet, etc.). As an example, the group tag may be included as a marking on an inner DSCP of a packet. In some examples, the group tag may determine or indicate what networks a user can access, application(s) the user can access, priority of traffic from the user, security permissions, etc.

As traffic that includes the group tag and may flows through different domains, consistency of policy enforcement may be maintained by creating common objects. The instantiation in each of the domains can use these common objects to come out with a domain specific deployment, while still maintaining and applying the cross-domain policy intent in a harmonious manner. Accordingly, the techniques may provide a global policy that enables enforcement within different domains that honoring the main aspects of the global policy, but with an ability to modify application or enforcement based on local resource availability within the particular domain. As an example, traffic received from a Meraki site may not include VRF constructs and traffic calling within Meraki may be based on IP addresses. In this example, tagging traffic with a particular group tag may occur within an SD-WAN fabric of the enterprise network and the system may then map the IP addresses together. In another example, traffic received from a SD-Access network may use VXLAN identifiers to map to VN identifiers. In this example, when the system sends traffic to the cloud network, the system may map the traffic to a cloud segmentation identifier.

Additionally, the policy module may include context associated with the global policy. As an example, the common enforcement for Application Routing may be translated to Switch QoS and/or to Wireless QoS Intent to achieve end-to-end common policy. Accordingly, the context may be created closer to the domain where it resides, such as the access layer for users and devices and in the data center or cloud for application workloads. This context may be normalized to a group construct, such as a group tag (e.g., Security Group Tag (SGT), that is understood across all of the domains. Accordingly, the system may tightly stitch domains (e.g., Wireless, Campus, SD-LAN, SD-WAN, Cloud and Data Center networking) with well-known application policies such that the system can, via integration with an authentication module, map applications to different group tags.

In some examples, the context or group tag may be associated with an industry vertical, such that network devices within a particular domain may, based on the group tag, apply policies associated with particular industries. As an example, the context may indicate that the industry vertical corresponds to a hospital network. In this example, the global policies may include policy definitions for enforcement of payment card industry (PCI) and/or Health Insurance Portability and Accountability Act (HIPAA) compliance for payment data or other regulatory requirements; policy definitions for implementing VLANs on Campus and Access points, and on WAN and cloud with VPC and Segmentation via VRF, and ensuring the right QoS marking for egress queues. Accordingly, unlike existing techniques, where network devices perform individualized segmentation for each domain (e.g., WAN, LAN, etc.), the techniques enable the network devices to more efficiently route traffic between domains without having to perform the individualized segmentation.

In some examples, the policy module may be configured to generate catalogs of pre-defined policy definitions associated with one or more industry topologies. For instance, the system may determine or learn based on data from a plurality of tenants, that a particular industry utilizes a particular network topology. The system may determine characteristics associated with the network topology, including domain(s) used, network device(s) used, policy definitions that tend to be implanted, features that users of the network(s) tend to utilize, compliance or regulatory restrictions, enforcement points, etc. The system may generate a catalog for the particular industry that comprises pre-defined policy definitions, including policy definitions for each domain within the topology, according to the data.

The system may include a catalog system. The catalog system may be included as part of the entity or global controller. In some examples, the catalog system may be a separate system hosted by a separate memory, system, device(s), entity, etc. The catalog system may be configured to generate, store, and/or provide catalogs of global policies associated with particular industry topologies. As noted above, each global policy may include policy definitions for each type of network device within a particular industry and domain.

As an example, a service provide may be Cisco and an industry topology may include a retail industry. In this example, the retail industry may utilize LAN and WAN and the catalog may include pre-defined policy definitions to enable access, connectivity, and endpoint functionality. For instance, examples of features in LAN for wired and wireless LANs that the catalog may include policy definitions of may include, but are not limited to, one or more of: VRF Segmentation, PCI, Departments/IoT-16-20 VRF per store average; IoT Security, Branch Security; MACSEC; Route Leak across VRF; Distributed Route Leak across WAN; OSPF/EIGRP/BGP Route Redistribution; HSRP/GLBP/VRRP—First Hop Redundancy; MultiCast; Badged Access Segmentation; Multi Factor Authentication; MAC Bypass; vXLAN/OTP support to integrate Branch and Campus; Identity Management Servers; Service Chaining Firewall; Multi Cloud Connectivity; Analytics for Local LAN; AI Analytics; Monitoring/SNMP/AAA/Tacacs/Netflow/Syslogs/Policy-Maps/Route-Maps/Route Filtering; Multiple Layers of Redundancy at external firewall, switch, with OSPF, BGP, complex routing policies; Handheld Scanner connectivity; Video Surveillance connectivity and analytics; Layer 7 and Layer 4 inspection with DPI; Selective segments available at select locations (e.g., such as tires, gas stations, etc.). Examples of features for WAN that the catalog may include policy definitions of may include, but are not limited to, one or more of: VRF Segmentation PCI, Departments; Local Security on-box, Cloud Security for SaaS applications; Policy Infrastructure: Application Aware Policy/Data Policy/Security Policy; SD-WAN Routers Mobile Stores/ATMs; SD-WAN Remote Access from Remote Users; Different topologies for connectivity across regions—Multi-Region Fabric (Zabka, Swaroski, Loblaw, FedEx, Continental Tires, Garmin); Voice—Full Mesh and VRF Dependent topologies; LAN to WAN/WAN to LAN OSPF/EIGRP/BGP Route Redistribution; HSRP/GLBP/VRRP—First Hop Redundancy; MultiCast; MAC Bypass; vXLAN support to integrate Branch and Campus; Multi-Cloud and Middle Mile Connectivity for Applications; Service Chaining Firewall; Local firewall on Routers; TLOC Extensions; DIA Security integration for Cloud/SaaS Applications integration with Cisco Secure Access (SIG Tunnel); Cloud On Ramp for SaaS; Cloud On Ramp for MultiCloud/Middle Mile networking; Enhanced Application aware routing; Smart LTE networking; Smart QoS Architecture—Per-Tunnel QoS/Adaptive Shaping; Topology independent VRF; Route Leak across WAN; Local Route Leak at select sites; Service Side NAT for acquisitions.

As another example, where a service provide is Cisco and the industry topology may be a banking industry. In this example, the topology may utilize a campus LAN and SD-WAN. Examples of features in a campus LAN that the catalog may include policy definitions of for a banking topology may include, but are not limited to, one or more of: VRF Segmentation HIPAA, PCI, Departments/IoT/ATM/Video Surveillance/Payment Scanner; IoT Security; OSPF/EIGRP/BGP Route Redistribution; HSRP/GLBP/VRRP—First Hop Redundancy; MultiCast—Badged Access Segmentation; Multi Factor Authentication for transactions/handheld security; MAC Bypass for certain devices; vXLAN support to integrate Branch and Campus and to DC networks; Identity Management Servers; Cloud Connectivity Banking Applications; Service Chaining Firewall; High volume transactions; Low Latency Queueing in networks; Loadbalancer, Application Servers, Trading Servers on LAN; QOS for transaction; DSCP Marking for Finance Applications; Monitoring/SNMP/AAA/Tacacs/Netflow/Syslogs/Policy-Maps/Route-Maps/Route Filtering; Multiple Layers of Redundancy at external firewall, switch, with OSPF, BGP, complex routing policies; Physical Security; ATM Security; Logging/Netflow/Application Visibility/Controller Monitoring/API Usage for SD-WAN enablement/Monitoring.

Examples of features for SD-WAN in a WAN that the catalog may include policy definitions of for a banking topology may include, but are not limited to, one or more of: VRF Segmentation HIPAA, PCI, Departments/x-Rays; IoT SD-WAN Routers/IoT Security; Policy Infrastructure: Application Aware Policy/Data Policy/Security Policy; SD-WAN Routers Mobile branches; SD-WAN Remote Access; Different topologies for connectivity across regions—MRF; LAN to WAN/WAN to LAN OSPF/EIGRP/BGP Route Redistribution; HSRP/GLBP/VRRP—First Hop Redundancy; MAC Bypass; vXLAN support to integrate Branch and Campus; Multi-Cloud and Middle Mile Connectivity for critical applications; Service Chaining Firewall; Local firewall on Routers; TLOC Extensions; DIA Security integration for Cloud/SaaS Applications integration with Cisco Secure Access (SIG Tunnel); Cloud On Ramp for SaaS; Enhanced Application aware routing; Smart LTE networking—Path of Last Resort; smart QoS Architecture—Per-Tunnel QoS/Adaptive Shaping; Topology independent VRF; Analytics for Network performance; Monitoring for WAN Failure and High availability HA Switchover for BFD/Router failures in networks; Multiple Route filtering, with BGP Community; Physical Security Video monitoring for ATM in isolated locations—Segmentation.

As another example, where a service provide is Cisco and the industry topology may be a hospital industry. In this example, the topology may utilize a campus LAN and SD-WAN. Examples of features in a campus LAN that the catalog may include policy definitions of for a hospital topology may include, but are not limited to, one or more of: VRF Segmentation for HIPAA, PCI, Departments/x-Rays/IoT; IoT Security; OSPF/EIGRP/BGP Route Redistribution; HSRP/GLBP/VRRP—First Hop Redundancy; MultiCast—Patient Interaction; Badged Access Segmentation; Multi Factor Authentication; MAC Bypass; vXLAN support to integrate Branch and Campus; Identity Management Servers; Cloud Connectivity for Clinical Applications; Service Chaining for patient applications/compliance/Firewall.

Examples of features for SD-WAN in a WAN that the catalog may include policy definitions of for a hospital topology may include, but are not limited to, one or more of: VRF Segmentation HIPAA, PCI, Departments/x-Rays; IoT SD-WAN Routers/IoT Security; Policy Infra: Application Aware Policy/Data Policy/Security Policy; SD-WAN Routers Mobile Clinic/Remote Clinics; SD-WAN Remote Access from Remote Clinics/Doctors; Different topologies for connectivity across regions—MRF; LAN to WAN/WAN to LAN OSPF/EIGRP/BGP Route Redistribution; HSRP/GLBP/VRRP—First Hop Redundancy; MultiCast; MAC Bypass; vXLAN support to integrate Branch and Campus; Multi-Cloud and Middle Mile Connectivity for Clinical Applications; Service Chaining Firewall; Local firewall on Routers; TLOC Extensions; DIA Security integration for Cloud/SaaS Applications integration with Cisco Secure Access (SIG Tunnel); Cloud On Ramp for SaaS; Cloud On Ramp for MultiCloud/Middle Mile networking; Enhanced Application aware routing; Smart LTE networking; Smart QoS Architecture—Per-Tunnel QoS/Adaptive Shaping; Topology independent VRF; Multi Region Fabric.

As another example, where a service provide is Cisco and the industry topology may be a manufacturing industry. In this example, the topology may utilize a campus LAN and SD-WAN. Examples of features in a campus LAN that the catalog may include policy definitions of for a manufacturing topology may include, but are not limited to, one or more of: VRF Segmentation HIPAA, PCI, Departments/IoT/ATM/Video Surveillance/Payment Scanner; IoT Security; OSPF/EIGRP/BGP Route Redistribution; HSRP/GLBP/VRRP—First Hop Redundancy; Badged Access Segmentation; Multi Factor Authentication for transactions/handheld security devices; MAC Bypass for certain devices; vXLAN support to integrate Branch and Campus and to DC networks—SDA—Cisco ACI infra, vXLAN for datacenter networking; Identity Management Servers; Cloud Connectivity Manufacturing Applications; Service Chaining Firewall for Core datacenter and Factory; 100% Up time application monitoring for shop floor, industrial automation/supply chain; QOS for transaction; DSCP Marking for Manufacturing and Process control applications; Monitoring/SNMP/AAA/Tacacs/Netflow/Syslogs/Policy-Maps/Route-Maps/Route Filtering; Multiple Layers of Redundancy at external firewall, switch, with OSPF, BGP, complex routing policies; Physical Security; Logging/Netflow/Application Visibility/Controller Monitoring/API Usage for SD-WAN enablement/Monitoring; SDA Integration across all Bosch Campus networks along with complex filtering policy on WAN Edge Routers.

Examples of features for SD-WAN in a WAN that the catalog may include policy definitions of for a manufacturing topology may include, but are not limited to, one or more of: VRF Segmentation HIPAA, PCI, Departments/x-Rays; IoT SD-WAN Routers/IoT Security; Policy Infra: Application Aware Policy/Data Policy/Security Policy; SD-WAN Remote Access; Different topologies for connectivity across regions—MRF; LAN to WAN/WAN to LAN OSPF/EIGRP/BGP Route Redistribution; HSRP/GLBP/VRRP—First Hop Redundancy; MAC Bypass; vXLAN support to integrate Branch and Campus/SDA connectivity; Multi-Cloud and Middle Mile Connectivity; Service Chaining Firewall; Local firewall on Routers; TLOC Extensions; DIA Security integration for Cloud/SaaS Applications integration with Cisco Secure Access (SIG Tunnel); Cloud On Ramp for SaaS; Enhanced Application aware routing; Smart LTE networking—Path of Last Resort; Smart QoS Architecture—Per-Tunnel QoS/Adaptive Shaping; Topology independent VRF; Analytics for Network performance; Monitoring for WAN Failure and High availability HA Switchover for BFD/Router failures in networks; Multiple Route filtering, with BGP Community tags; Physical Security Video monitoring—locations—Segmentation; High Availability and SLA Monitoring for Business Applications for AAR Steering.

In this way, the system may provide instant access to cloud network applications via group tags, consistent security and QoS Enforcement across domains, ensure path selection is correctly marked and applications are not programmed on Campus WAN is firewall is set to drop such applications via App Route Policy; and provide consistent application group enforcement (such as in SD-LAN and SD-WAN) to provide a seamless end to end experience. Moreover, by utilizing data to determine each industry vertical intent, the system can generate a catalog feature to auto create policy (including VRF requirements) like a pre-defined template that enables a customer to deploy a Wireless, CAMPUS Switching infrastructure, WAN connectivity, Cloud Connectivity all with few clicks, thereby enabling simpler IT workflows for customers. Further, by automatically determining a network infrastructure and generating policy definitions for the enterprise network, the techniques can stitch information together across domains without a user having to go into each controller and manually configure policies for each of the domains and controllers.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

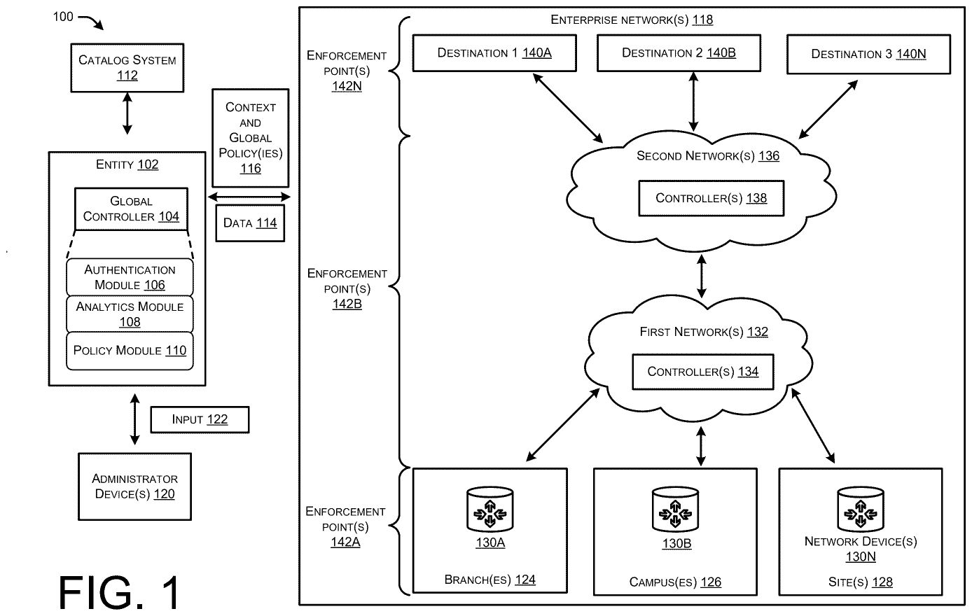

FIG. 1 illustrates a system-architecture diagram of an environment in which a system 100 can generate and provide catalog(s) and global policies for enterprise networks. While the system 100 shows an example entity 102 and example enterprise network(s) 118, it is understood that any of the components of the system 100 may be implemented on any device associated with the system 100 and/or any cloud-based service provider. While the techniques described herein are in relation to an enterprise network and network devices, it is understood that the techniques may be applied to third-party networks and third-party devices (e.g., such as non-Cisco devices), such that the global policy may still be applied in a harmonized way to traffic to the third-party devices.

In some examples, the system 100 may include entity 102. In some examples, the entity 102 may correspond to a centralized entity of a service provider that manages an enterprise network 118 end-to-end. For instance, the entity 102 may correspond to Cisco's global manager feature.

In some examples, entity 102 may include a global controller 104. In some examples, the global controller 104 corresponds to a system that has complete visibility into the fabric of a given network. In some examples, the global controller 104 may comprise a controller, one or more processors, memory etc.

As illustrated, the global controller 104 may include an authentication module 106, an analytics module 108, and a policy module 110. In some examples, the authentication module 106 may correspond to an authentication, authorization, and access engine, such as Cisco's Identity Services Engine (ISE). In some examples, the authentication module 106 is configured to receive user data (e.g., such as user credentials when accessing an enterprise network) from the user device and/or via a network device. The authentication module 106 may authenticate the user data by comparing the user data to data stored by the authentication module. Where the user data matches, the authentication module may assign a group tag to the user based on a role and/or group associated with the user and identified by the authentication module. In some examples, group tags correspond to Security Group Tags (SGTs). In some examples, the authentication module 106 may assign the group tag based on context, such as user device type, security posture, user location, etc. For instance, a user within a management department of an enterprise network may be assigned a group tag that associates the user device with the management group. The authentication module 106 may further assign a group tag that is associated with context of a global policy. For instance, the group tag may be associated with a quality of service for a particular user, group of users, type of data, etc. for one or more domains within the enterprise network.

In some examples, the analytics module 108 may comprise an analytics engine. In some examples, the analytics module may correspond to Cisco's vAnalytics feature and may be implemented as part of the entity 102 or as a separate feature. In some examples, the analytics module 108 is configured to collect data 114. In some examples, the analytics module may be configured to learn policies configured or defined for different domains in enterprise network(s) of different tenants. In some examples, the analytics module may be configured to identify patterns associated with policies utilized within a particular industry topology. In some examples, the analytics module 108 may be configured to perform or assist the policy module 110 in the auto-generation of policy definitions for a user's enterprise network. For instance, the analytics module 108 may be configured to extract context data and/or policy data from segments of the enterprise network 118 and/or other network(s) and may identify and push updated policies to the enterprise network 118 (e.g., such as to the first network(s) and/or the second network(s)). In some examples, the analytics module 108 may be configured to engineer, based on the WAN, policy definitions for a campus network automatically.

In some examples, the analytics module 108 may comprise one or more pre-trained models and/or pre-trained weighted models. In some examples, the artificial intelligence models are pre-trained using machine learning techniques. In some examples, the change window system may store machine-trained data models for use during operation. Machine learning techniques include, but are not limited to supervised learning algorithms (e.g., artificial neural networks, Bayesian statistics, support vector machines, decision trees, classifiers, k-nearest neighbor, etc.), regression models, unsupervised learning algorithms (e.g., artificial neural networks, association rule learning, hierarchical clustering, cluster analysis, etc.), semi-supervised learning algorithms, deep learning algorithms, etc. [symbol] , statistical models, etc. As used herein, the terms “machine learning,” “machine-trained,” and their equivalents, may refer to a computing model that can be optimized to accurately recreate certain outputs based on certain inputs.

Machine learning techniques include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs. In some examples, the machine learning models include deep learning models, such as convolutional neural networks (CNN), deep learning neural networks (DNN), and/or artificial intelligence models. The term “neural network,” and its equivalents, may refer to a model with multiple hidden layers, wherein the model receives an input (e.g., a vector) and transforms the input by performing operations via the hidden layers. An individual hidden layer may include multiple “neurons,” each of which may be disconnected from other neurons in the layer. An individual neuron within a particular layer may be connected to multiple (e.g., all) of the neurons in the previous layer. A neural network may further include at least one fully-connected layer that receives a feature map output by the hidden layers and transforms the feature map into the output of the neural network. In some examples, the neural network comprises a graph where each node of the graph represents a layer within the neural network. Each node may be connected as part of a chain (e.g., a concatenation of layers). In some examples, input may be received by a node within the graph, the input is computed by the node and gets passed to one or more additional nodes in the chain.

In some examples, the models may be updated and/or re-trained in real-time. For instance, the system may update the models based on real-time flow data received across networks and/or across tenants. Accordingly, the system may provide more accurate modeling of behavior of a user in a plurality of different conditions, environments, locations, etc.

In some examples, the policy module 110 is configured to generate global policies that include context (e.g., associated with a group tag) that can be shared across domains within an enterprise network. For instance, the policy module 110 may determine that an input is received from an administrator device, the input indicating a network intent. The network intent may specify, at a high-level, particular user groups, types of data, priority of the data, etc. Based on the network intent, the policy module may automatically determine a topology (type(s) of domains, number, types, and features of network device(s), etc.) of the enterprise network of the administrator. The system may, based on the network, generate policy definitions for each of the domains based on the network intent as part of a global policy. The global policy may be sent to the network devices for implementation and enforcement automatically or based on input approving the policy definitions received from the administrator.

In some examples, the policy module 110 may generate the global policy based on determining the network intent is associated with a pre-defined industry vertical topology. In this example, the policy module may automatically generate policies for wireless, SD-LAN, SD-WAN, etc., while taking into account the LAN and WAN needs. For instance, the policy module 110 may generate SLA requirements for WAN, Nat Dia policies, Data and Control Policies for WANs, while also creating a BGP EVPN configuration policy for a CAMPUS LAN, and creating a pre-defined VLAN, VRF, and QoS policy for integrating LAN traffic and Wireless controllers and access points in the enterprise network.

In some examples, the policy module 110 may integrate the network intent as context included in the global policy. For instance, the context may be associated with a group tag (e.g., such as a security group tag or other group construct). Additionally, the policy module may include context associated with an industry vertical, such that network devices within a particular domain may, based on the group tag, apply policies associated with particular industries. As an example, the context may indicate that the industry vertical corresponds to a hospital network. In this example, the global policies may include policy definitions for enforcement of PCI/HIPAA compliance for payment or regulatory requirements, followed by VLANs on Campus and Access points, and on WAN and cloud with VPC and Segmentation via VRF, and ensuring the right QoS marking for egress queues. Accordingly, unlike existing techniques, where network devices perform individualized segmentation for each domain (e.g., WAN, LAN, etc.), the techniques enable the network devices to more efficiently route traffic between domains without having to perform the individualized segmentation.

In some examples, the policy module 110 may be configured to generate catalogs of pre-defined policy definitions associated with one or more industry topologies. For instance, the system may determine or learn based on data from a plurality of tenants, that a particular industry utilizes a particular network topology. The system may determine characteristics associated with the network topology, including domain(s) used, network device(s) used, policy definitions that tend to be implanted, features that users of the network(s) tend to utilize, compliance or regulatory restrictions, enforcement points, etc. The system may generate a catalog for the particular industry that comprises pre-defined policy definitions, including policy definitions for each domain within the topology, according to the data.

The system may include a catalog system 112. The catalog system may be included as part of the entity or global controller. In some examples, the catalog system may be a separate system hosted by a separate memory, system, device(s), entity, etc. The catalog system may be configured to generate, store, and/or provide catalogs of global policies associated with particular industry topologies. For instance, the catalog system 112 may be configured to interface with administrator device(s) 120 to display, update, and/or customize catalog(s) of policies generated for a particular industry vertical/industry topology. For instance, the catalog system 112 may receive input 122 indicating a particular industry vertical. In response the catalog system 112 may retrieve and display the pre-defined policies for that industry vertical. In some examples, the administrator device may provide additional input indicating customizations to one or more of the pre-defined policies. The catalog system may receive additional input indicating a request to implement the catalog in an enterprise network of a user. In response, the catalog system may send the catalog to the enterprise network, such that the network devices may be programmed to enforce the pre-defined policies on traffic. In some examples, the controller(s) 134 and controller(s) 138 may be configured to access the catalog system 112 to download the catalog or portion(s) of the catalog. For instance, a controller for a WAN network may download portions of the catalog that includes pre-defined policies for routing traffic between the WAN and one or more of the domains.

In some examples, the global controller 104 and/or catalog system 112 may be configured to communicate with administrator device(s) 120. As illustrated, the administrator device(s) 120 may include an application (not shown) that is provided by a service provider (e.g., such as Cisco) that enables an administrator of the enterprise network 118 to access the global controller 104 and/or catalog system 112, as well as various features of the enterprise network. For instance, the administrator device(s) 120 may be configured to send input 122 to the entity 102 and/or catalog system 112. The input 122 may include an indication of a network intent of the administrator and/or a request for an industry catalog.

In some examples, the system 100 may include enterprise network(s) 118 that include network device(s) 130. The enterprise network 118 may include one or more networks implemented by any viable communication technology, such as wired and/or wireless modalities and/or technologies. The enterprise network 118 may include any combination of Personal Area Networks (PANs), SDCI, Local Area Networks (LANs), Campus Area Networks (CANs), Metropolitan Area Networks (MANs), extranets, intranets, the Internet, short-range wireless communication networks (e.g., ZigBee, Bluetooth, etc.), Wide Area Networks (WANs)—both centralized and/or distributed, SD-WANs, SDNs—and/or any combination, permutation, and/or aggregation thereof. The enterprise network 118 may include devices, virtual resources, or other nodes that relay packets from one network segment to another by nodes in the computer network. The enterprise network 118 may include multiple devices that utilize the network layer (and/or session layer, transport layer, etc.) in the OSI model for packet forwarding, and/or other layers.

The entity 102 may be configured to communicate with the enterprise network 118. For instance, the entity 102 may receive data 114 that the entity can use in generating global policy(ies) and/or catalogs. In some examples, data 114 includes flow data, such as network traffic load data, network client data, application load data, data associated with WLCs, APs, etc., as well as user data. User data may comprise user authentication data, such as user credentials, user device identifiers (e.g., such as an IP address, etc.), or any other user data. Flow data may comprise one or more application characteristics and/or network characteristics. The application characteristics may comprise one or more of flow telemetry (e.g., an application identifier, flow count—how many flows is the application creating, bytes, octets, bandwidth requirements, a number of users that access the application, drops, event(s) associated with the drops, DSCP markings); interface data (e.g., bandwidth utilization, total octets, packet(s), maximum supported line rate, tail drops, etc.); link characteristics (e.g., internet service provider (ISP) name, purchased bandwidth or available maximum bandwidth, link type (e.g., MPLS, Internet, LTE, etc.), geographic region, etc.); quality of service (QoS) prioritization requirements (e.g., low latency queuing, bandwidth reservation, etc.); application quality metrics (e.g., application performance index, application telemetry, application feedback, etc.); and/or any other suitable data or characteristic.

In some examples, the entity 102 may send context and global policy(ies) 116 to the enterprise network 118 such that the network device(s) 130 may enforce the policies uniformly and consistently across domain(s) (e.g., network(s) such as first network(s) 132, second network(s) 136, etc., and/or destination(s) 140).

The network device(s) 130 may comprise routers, switches, access points, stations, radios, or any other network device. For instance, the global controller 104 may be configured to send context and global policy(ies) 116 to the enterprise network 118. In some examples, the context is included as part of the global policy(ies).

In some examples, the network device(s) 130 may enforce the global policy using the context associated with the group tag included in packet(s). In some examples, the network device(s) 130 may enforce the behavior aware policies using the user device identifier to behavior group mapping(s) received and/or updated from the system. For instance, the network device(s) 130 may identify and apply a user behavior aware policy based on the group tag and the user-IP address to behavior group mapping.

In some examples, the enterprise network 118 may comprise branch(es) 124. In some examples, the branch(es) 124 comprise user(s), mobile device(s), and/or Internet of Things (IOT) device(s) located at one or more locations. In some examples, the branch(es) 124 may comprise one or more network device(s) 130A (e.g., switch(es), firewall(s), etc.) and/or user device(s) that may communicate with the enterprise network(s) 118 via network device(s) 130A.

In some examples, the enterprise network 118 may comprise campus(es) 126. In some examples, the campus(es) 126 comprise user(s), mobile device(s), and/or Internet of Things (IOT) device(s) located at one or more locations. In some examples, the campus(es) 126 may comprise one or more network device(s) 130B (e.g., switch(es), routers, access points, firewall(s), etc.) and/or user device(s) that may communicate with the enterprise network(s) 118 via network device(s) 130B.

In some examples, the enterprise network 118 may comprise site(s) 128. In some examples, the site(s) 128 may comprise one or more network device(s) 130N (e.g., switch(es), routers, access points, servers, firewall(s), etc.) and/or user device(s) that may communicate with the enterprise network(s) 118 via network device(s) 130N.

As illustrated, the branch(es) 124, campus(es) 126, site(s) 128 may communicate with destination(s) 140 (illustrated as destination 1 140A, destination 2 140B, and destination 3 140N) via first network(s) 132 and/or second network(s) 136. In some examples, the first network(s) 132 may correspond to a local area network within the enterprise network, such as an SD-LAN. As illustrated, the first network(s) 132 may include controller(s) 134. The controller(s) 134 may correspond to wireless controllers that enable features of a service provider (e.g., such as for a LAN, the controller(s) 134 may correspond to Cisco's catalyst center feature, for a cloud network, the controller(s) 134 may correspond to cloud controllers, etc.). In some examples, the second network(s) 136 may correspond to a local area network within the enterprise network, such as an SD-LAN. As illustrated, the second network(s) 136 may include controller(s) 138. The controller(s) 138 may correspond to wireless controllers that enable features of a service provider (e.g., such as for a WAN, the controller(s) 138 may correspond to Cisco's vManage feature, vAnalytics feature, etc.).

In some examples, destination 1 140A may correspond to a first endpoint or domain. For instance, destination 1 140A may correspond to a data center. Destination 2 140B may correspond to a second endpoint or domain. For instance, destination 2 140B may correspond to a multi-cloud network, SD-Access, or a campus network. Destination 3 140N may correspond to a third endpoint or domain. For instance, destination 3 140N may correspond to an internet domain, SaaS cloud, cellular gateway, etc. While the domains are described as being associated with different destinations, it is understood that one or more of destination 1 140A, destination 2 140B, and/or destination 3 140N may be associated with a same or similar endpoint. Further, as noted above, the domains may include WAN, LAN, or other networks.

As illustrated, the enterprise network 118 may include various enforcement point(s) 142 (illustrated as enforcement point(s) 142A, enforcement point(s) 142B, and enforcement point(s) 142N). Enforcement point(s) 142A may represent enforcement point(s) for enforcing the global policy according to the network intent when sending traffic from one of the branch(es) 124, campus(es) 126, and/or site(s) 128 to a first domain (e.g., such as destination 1), according to a particular industry vertical or industry topology. In some examples, enforcement point(s) 142A may correspond to access enforcement points. It is understood that the enforcement point(s) 142A for sending traffic from site(s) 128 to destination 1 140A may differ from enforcement point(s) 142A for sending traffic from site(s) 128 to destination 2 140B. Similarly, it is understood that the enforcement point(s) 142A for sending traffic from site(s) 128 to destination 1 140A may differ from enforcement point(s) 142A for sending traffic from campus(es) 126 to destination 1 140A.

In some examples, enforcement point(s) 142B may correspond to connectivity enforcement points, such as enforcement of the global policy according to network intent within the first network(s) 132 and/or second network(s) 136. Enforcement point(s) 142N may correspond to endpoint or domain enforcement points, such as enforcement of the global policy according to network intent for traffic being received or sent by a particular domain, as well as how the traffic is handled by the domain.

Accordingly, when enforcing the global policies at the first network(s) 132 (e.g., such as a LAN) of the enterprise network, one or more policy constructs may be utilized (e.g., such as QoS, Application Tagging, DSCP marking, Priority Queuing Policy enforcement, etc.). For instance, when traffic comes into a router of the first network(s) 132, the QoS markings on those packets (e.g., connecting from a desktop/IP phone, there is a voice queue packet tag) indicate priority. For voice traffic, the system may know, based on the user intent, that the user doesn't want the traffic to drop or the voice experience to degrade. Accordingly, the system may configure policies to cause the network device(s) 130 to place the traffic in queue zero (e.g., a highest priority queue) and mark the packets with the queue zero indication (e.g., such as with a DSCP marking). The system may also make sure that the correct queue on the router is configured to recognize that when traffic comes in from a desktop phone, which is connected to a switch, which is connected to a wireless/wired network that connects to the router, the router can identify the traffic as voice, video, etc. traffic and automatically route the traffic as high priority. When packet is sent out, the global policy may configure the network devices to mark the inner DSCP, so that when the service provider receives the packet, even though the traffic is encrypted, the outer header will indicate how the traffic should be treated without exposing the data or payload inside the packet itself. When traffic reaches the data center/termination point (e.g., such as destination 1), the traffic may be decapsulated and forwarded to a destination on the LAN side to reach the final destination. When traffic is marked with DSCP marking, the traffic is treated according to priority across the network. Thus, the system may create policies at the entity 102 and push them to the network devices (e.g., based on type of traffic, identifier, group tag, etc.). In some examples, the global policy may include policies for the switches that are different from policies for the routers of the LAN.

Policy constructs for the second network(s) (e.g., such as the WAN or WAN policy) may include one or more of SLA Mapping for application groups, Direct Internal Policy for Applications along with vQE Scores for SLAs, Application Routing SLA for applications and custom applications, Service Discovery for cloud applications, and instant policy orchestration for cloud application path steering. Policy constructs for cloud network policy may include VPC, VNET Tagging, symmetric routing policy enforcements for cloud policies. Accordingly, by routing traffic from the LAN to a WAN, security for policy enforcement may be provided. For instance, routing traffic from a LAN to WAN may require authentication of a user identity, device identity, group tag, etc., which may be performed by the authentication module 106.

In this way, the system may provide an industry enabled topology and functionality involving access, connectivity and endpoint (e.g., such as datacenter, cloud, etc.), thereby providing a single global policy that can be enforced consistently across the enterprise. The system further enables a network administrator to customize the global (e.g., end to end) policy between multiple domains utilizing catalog(s) that include pre-defined global policy definitions for particular industry verticals. Moreover, the system streamlines routing of traffic between domains, by utilizing network intent and automatically identifying a topology of a user's enterprise network to auto-generate a global policy that includes policies for each domain within the enterprise. Thus, a network administrator no longer needs to configure policies for each domain within the enterprise network. Moreover, by sharing context between domains of the enterprise network, network devices no longer need to perform individualized segmentation of traffic for each domain.

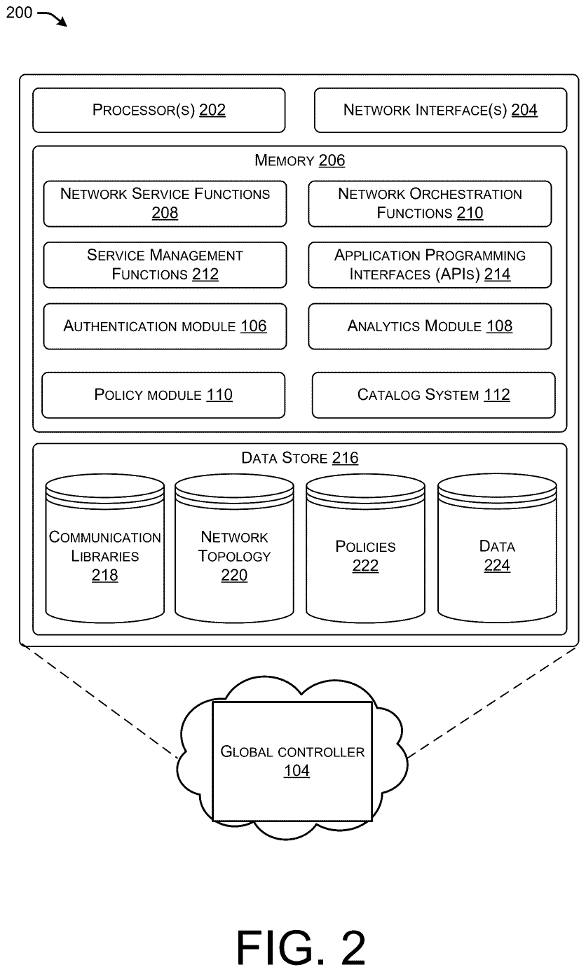

FIG. 2 illustrates a component diagram 200 of an example entity 102 described in FIG. 1. In some instances, the entity 102 may run on one or more computing devices in, or associated with, the enterprise network(s) 118 (e.g., a single device or a system of devices) and/or system 100. In some instances, the entity 102 may be integrated as part of a centralized feature for managing end-to-end network communications (e.g., such as Cisco's Global Manager feature).

Generally, the entity 102 may include a programmable controller that manages some or all of the control plane activities of the enterprise network 118, and manages or monitors the network state using one or more centralized control models.

As illustrated, the entity 102 may include, or run on, one or more hardware processors 202 (processors), one or more devices, configured to execute one or more stored instructions. The processor(s) 202 may comprise one or more cores. Further, the global controller 104 may include or be associated with (e.g., communicatively coupled to) one or more network interfaces 204 configured to provide communications with network device(s) 130 and other devices, and/or other systems or devices in the enterprise network 118 and/or remote from the enterprise network 118. The network interfaces 204 may include devices configured to couple to personal area networks (PANs), wired and wireless local area networks (LANs), wired and wireless wide area networks (WANs), SDCI's, and so forth. For example, the network interfaces 204 may include devices compatible with any networking protocol.

The entity 102 may also include memory 206, such as computer-readable media, that stores various executable components (e.g., software-based components, firmware-based components, etc.). The memory 206 may generally store components to implement functionality described herein as being performed by the global controller 104. The memory 206 may store one or more network service functions 208, such as a slicing manager, a topology manager to manage a topology of the enterprise network 118, a host tracker to track what network components are hosting which programs or software, a switch manager to manage switches of the enterprise network 118, a process manager, and/or any other type of function performed by the global controller 104.

The entity 102 may further include network orchestration functions 210 stored in memory 206 that perform various network functions, such as resource management, creating and managing network overlays, programmable APIs, provisioning or deploying applications, software, or code to hosts, and/or perform any other orchestration functions. Further, the memory 206 may store one or more service management functions 212 configured to manage the specific services of the enterprise network 118 (configurable), and one or more APIs 214 for communicating with devices in the enterprise network 118 and causing various control plane functions to occur.

The entity 102 may include authentication module 106. As noted above, the authentication module 106 may correspond to an authentication, authorization, and access engine, such as Cisco's Identity Services Engine (ISE). Further, as noted above, the authentication module may assign a group tag to the user based on a role and/or group associated with the user and identified by the authentication module. In some examples, group tags correspond to Security Group Tags (SGTs). In addition, the authentication module 106 may be configured to assign a group tag based on context associated with a network intent. For instance, the network intent may be translated into context data, such as Switch QoS, Wireless QoS Intent, etc. The context data may be associated with a group tag that can then be assigned to traffic (e.g., such that traffic may include the group tag as a DSCP marking) and is understood across all domains of an enterprise network. In some examples, the context data may be associated with a particular industry vertical and/or requirements for a particular industry. For instance, where the industry is a hospital, the context data may be associated with a group tag that indicates HIPPA compliance is required. Accordingly, the authentication module 106 may enable mapping of application traffic to group tags associated with users, as well as context.

The entity 102 may include analytics module 108. As noted above, the analytics module 108 may comprise an analytics engine. In some examples, the analytics module may correspond to Cisco's vAnalytics feature and may be implemented as part of the entity 102 or as a separate feature. In some examples, the analytics module 108 is configured to collect data 114 and/or input 122 and may auto-generate policies for an enterprise network. For instance, the analytics module may receive a high-level network intent (e.g., such as an intent indicating that “for Users in group Y and traffic for Application X, provide Z QoS”). In response, the analytics module may automatically analyze and determine a network topology of the enterprise network (e.g., identifying the number and types of network devices, types of domains, locations of the network devices, capabilities, etc.) and may automatically generate a global policy that includes policy definitions for each device and domain to ensure traffic is routed according to the network intent and that application of the global policy is applied consistently across the domains.

The entity 102 may include policy module 110. In some examples, the analytics module may be integrated as part of the policy module 110. In some examples, the policy module 110 is configured to automatically and in response to a user's intent, generate global policies that include context (e.g., associated with a group tag) that can be shared across domains within an enterprise network. In some examples, the policy module 110 may automatically or in response to a user's input, program the global policy for an enterprise network of the user. In some examples, the policy module 110 may be configured to generate catalogs of pre-defined policy definitions associated with one or more industry topologies. For instance, the system may determine or learn based on data from a plurality of tenants, that a particular industry utilizes a particular network topology. The system may determine characteristics associated with the network topology, including domain(s) used, network device(s) used, policy definitions that tend to be implanted, features that users of the network(s) tend to utilize, compliance or regulatory restrictions, enforcement points, etc. The system may generate a catalog for the particular industry that comprises pre-defined policy definitions, including policy definitions for each domain within the topology, according to the data.

In some examples, the entity 102 may include catalog system 112. In some examples, the catalog system 112 may perform one or more operations of the policy module 110, analytics module 108, and/or authentication module 106. In some examples, the catalog system may be configured to generate, store, output, update, and/or implement catalogs of global policies associated with particular industry topologies. For instance, the catalog system 112 may be configured to interface with a user device (e.g., such as an administrator device 120) to display, update, and/or customize catalog(s) of policies generated for a particular industry vertical/industry topology. For instance, the catalog system 112 may receive input 122 indicating a selection of a particular industry vertical. In response the catalog system 112 may retrieve and display the pre-defined policies for the selected industry vertical. In some examples, the catalog system 112 may receive additional input indicating an approval to implement the catalog in an enterprise network. In some examples, the additional input may indicate customizations to one or more of the pre-defined policies in the catalog. The catalog system 112 may store the customized catalog in association with an account of the user. In response, the catalog system may send the catalog to the enterprise network, such that the network devices may be programmed to enforce the pre-defined policies on traffic. In some examples, the catalog system 112 may be configured to receive requests from controller(s) 134 and controller(s) 138 of the enterprise network to download the catalog (or customized catalog) or portion(s) of the catalog. For instance, a controller for a WAN network may download portions of the catalog that includes pre-defined policies for routing traffic between the WAN and one or more of the domains. Accordingly, the controller may store portions of the catalog that include pre-defined or customized policies for routing traffic between WAN and LAN, WAN and cloud networks, WAN and datacenters, etc.

In some examples, the global controller 104 and/or catalog system 112 may be configured to communicate with administrator device(s) 120. As illustrated, the administrator device(s) 120 may include an application (not shown) that is provided by a service provider (e.g., such as Cisco) that enables an administrator of the enterprise network 118 to access the global controller 104 and/or catalog system 112, as well as various features of the enterprise network. For instance, the administrator device(s) 120 may be configured to send input 122 to the entity 102 and/or catalog system 112. The input 122 may include an indication of a network intent of the administrator and/or a request for an industry catalog.

The entity 102 may further include a data store 216, such as long-term storage, that stores communication libraries 218 for the different communication protocols that the global controller 104 is configured to use or perform. Additionally, the data store 216 may include network topology data 220, such as a model representing the layout of the network components in the enterprise network 118 and/or data indicating available bandwidth, available CPU, delay between nodes, computing capacity, processor architecture, processor type(s), etc.. The data store 216 may store policies 222 that includes global policies, routing policies, security data associated with the network, security policies configured for the network, firewall policies, firewall configuration data, security posture data, and/or compliance policies configured for the network. The data store 216 may store data 224 that includes flow data, network data, feature data, domain data, user data, behavior model(s), application model(s), impact analysis data, and/or any other data described herein.

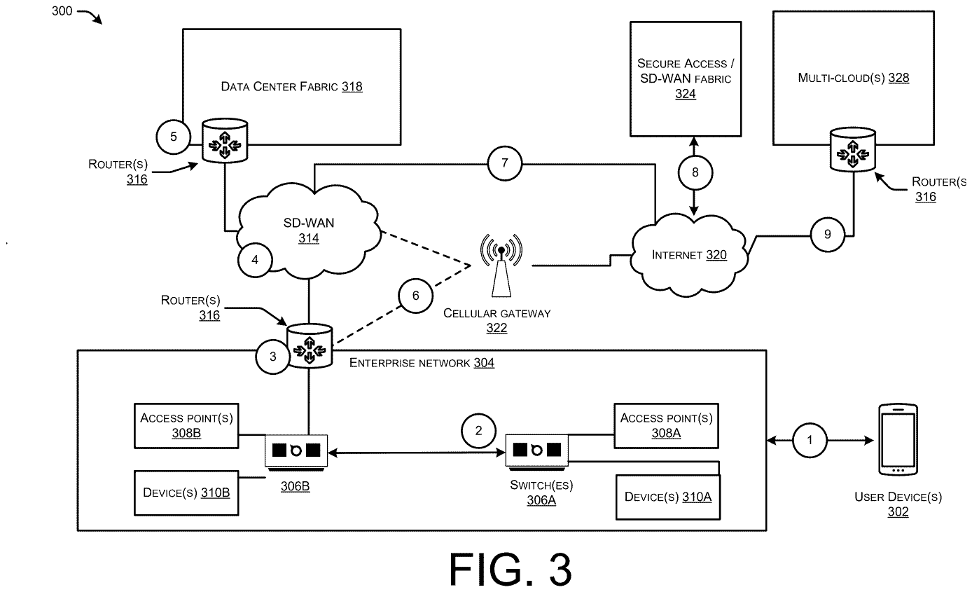

FIG. 3 illustrates an example environment 300 showing how a global policy may be enforced end-to-end in an industry network, according to the techniques described in FIGS. 1-2. In some examples, the environment 300 may represent a retail industry topology. While FIG. 3 is described in relation to a retail industry topology, it is understood that any industry topology may be utilized.

As illustrated, the environment 300 may include user device(s) 302. In some examples, the user device(s) 302 may correspond to a customer device, such as a cell phone, a tablet, or any other mobile computing device.

The environment 300 may also include enterprise network 304, which may correspond to enterprise network(s) 118 described above. In the illustrated example, the enterprise network 304 may represent a retail store. The enterprise network may include switch(es) 306A and/or switch(es) 306B. In some examples, one or more of the switch(es) 306A and/or switch(es) 306B may correspond to Cisco Catalyst wireless switches or third-party switches. In some examples, the switch(es)As illustrated, the switch(es) 306A may be connected to access point(s) 308A (e.g., either a wired or wireless access point) and/or one or more device(s) 310A. For instance, device(s) 310A may include one or more of cameras, computers, handheld scanners, or any other device utilized within or by the retail store. Similarly, the switch(es) 306B may be connected to access point(s) 308B (e.g., either a wired or wireless access point) and/or one or more device(s) 310B. For instance, device(s) 310B may include one or more of cameras, computers, handheld scanners, or any other device utilized within or by the retail store. Further, switch(es) 306B may be connected to router(s) 316 (e.g., such as Cisco SD-WAN router(s), third-party router(s), etc.).

As described above, the router(s) 316, the switch(es) 306A, 306B, access point(s) 308A, 308B, etc. and/or any of the network device within the environment 300 may implement all of or a portion of a global policy. For instance, the global policy may program the access point(s) 308A, 308B to identify the users who will connect to the enterprise network 304 (e.g., customers, employees, video cameras, devices, barcode readers, scanners, etc.) and may specify what data is allowed to come into the enterprise network via the access point(s) 308A, 308B. The global policy may further program policies to determine how to tag the traffic, such as with group tags by department/SGT markings, a priority of the traffic, DSCP markings, etc. In some examples, the policies within the global policy that are associated with the switches are programmed on the switches via a controller of the enterprise network 304. The global policy may include router policies, such as determining markings associated with the traffic. For instance, the policies may specify whether a router should mark traffic with a DSCP marking where it determines the traffic does not already include the DSCP marking. Additionally, the router policies say how the routers are to treat traffic that is inbound and how to route the outbound traffic (e.g., such as priority, QoS requirements, etc.).

In some examples, the global policy may define policies for segment routing within a service provider network, enabling a network administrator of the enterprise network to engineer underlay traffic of the service provider network (e.g., such as the SD-WAN 314, data center fabric 318, etc.). In some examples, policies may be enforced at a router 316 of the data center fabric 318, such as when traffic egresses out of the data center fabric 318 and/or when the traffic is decapsulated. In some examples, the policies may determine how, when incoming traffic is received from a LAN/WAN, to advertise the traffic back to the LAN/WAN. In some examples, the policies at one or more of the router(s) 316 may the same or different policies than the policies enforced at the edge (e.g., such as the router 316 of the enterprise network. Similarly, while not illustrated, the global policy may include policies for switches within the data center fabric 318.

The global policy may also include policies for multi-cloud(s) 328, where the multi-cloud 328 is connected to the SD-WAN 314 (e.g., such as where a switch is not directly connected to the multi-cloud 328, such that the SD-WAN 314 and/or routers of the SD-WAN can be implemented as part of the multi-cloud 328 infrastructure). In some examples, the cloud policies may be cloud specific (AWS policy is different than Azure cloud, etc.).

At “1”, a user (e.g., such as a customer) may connect to the enterprise network 304 via the user device 302. For instance, the user may use the user device to shop. In some examples, the user device 302 connects to access point(s) 308A, which as also connected to device(s) 310A.

At “2”, data from the user device 302 and the device(s) 310A comes into the enterprise network 304 via a switch(es) 306A, such as via a catalyst wireless switch. The switch(es) 306A may determine whether to tag the data with DSCP markings, group tags, etc. to generate catalyst switch data and may send the catalyst switch data to switch(es) 306B.

At “3”, the switch(es) 306B send the catalyst switch data to router(s) 316 at the edge of the enterprise network. The router(s) 316 may determine that a portion of the traffic (e.g., a portion of the catalyst switch data) is being sent to the data center fabric 318.

At “4”, where the router(s) 316 determine that the portion of the traffic (e.g., a portion of the catalyst switch data) is being sent to the data center fabric 318, the router(s) 316 may connect to the SD-WAN 314. Routers within the SD-WAN may connect to router(s) 316 of the data center fabric 318.

At “5”, the portion of the traffic sent to the router(s) 316 of the data center fabric 318. In the data center fabric 318, features of the service provider, such as the authentication module 106 may be implemented to perform identity management and may assign, verify, and/or update group tags, DSCP markings, etc.

At “6”, the router(s) 316 of the enterprise network 304 and/or the SD-WAN 314 may determine that a portion of the traffic has an LTE link (e.g., such as 3G, 4G, 5G, etc.). In this example, the SD-WAN and/or router(s) 316 may connect to a cellular gateway 322 (e.g., such as a cell tower), which may then connect to internet 320 and/or other wireless services.

At “7”, the router(s) 316 of the enterprise network 304 and/or the SD-WAN 314 may determine that a portion of the traffic relates to the user wanting to compare prices with other merchants and/or that a portion of the traffic relates to a user accessing a particular application (e.g., AWS, etc.). In this example, the portion of the traffic may be routed from the SD-WAN 314 and through the internet 320.

At “8”, continuing from step 7, the portion of the traffic related to the user wanting to compare prices with other merchants is then routed through the Secure Access/SD-WAN fabric 324 to a SaaS cloud. By routing the traffic through the SD-WAN fabric (e.g., and/or Cisco's secure access feature), the environment 300 is able to inspect and protect the traffic destined for the SaaS cloud.

At “9”, continuing from step 7, the portion of the traffic related to the user wanting to access a particular application may be routed through router(s) 316 of a multi-cloud 328, such as an SD-WAN router. The traffic may then be sent to the application e.g., such as the AWS cloud, which may perform a security check to inspect the traffic.

In some examples, tagging traffic or enforcement of policies can be performed by the routers that have tagging/marking capabilities, the authentication module 106, and/or an upstream device having the capabilities to mark the traffic. For instance, where a particular router does not have the capability to perform traffic tagging or marking, the router may notify the authentication module. The authentication module 106 may determine an upstream router that includes the capability to mark the packet and may notify the upstream device to mark and forward the packet using a protocol (e.g., such as SGT exchange protocol (SXP) protocol or any suitable protocol). In some examples, the authentication module 106 may perform identity management and can be used to facilitate DSCP markings on an egress packet using the SXP protocol.

In this way, the system may enable enabling a network administrator to customize end-to-end policy between multiple domains utilizing catalog(s) and/or automatically generating policies based on the administrator's intent (also referred to as network intent). The global policy may be implemented by network devices across domains of an enterprise network, thereby enabling consistent policy enforcement across domains of the enterprise network, while providing security between domains and ensuring harmonious enforcement of the global policy. Thus, the techniques may provide a seamless end-to-end customer experience. Moreover, by integrating the SD-WAN router into a multi-cloud infrastructure, the techniques enable cloud-specific policies to be enforced for each cloud. Further, as illustrated in FIG. 3, the techniques and global policy enable an enterprise network to move traffic across and between domains with a single expression of network intent. Thus, the network devices do not need to perform individualized segmentation at each domain and the network administrator does not need to manually configure separate policies for each controller within each domain of the enterprise network.

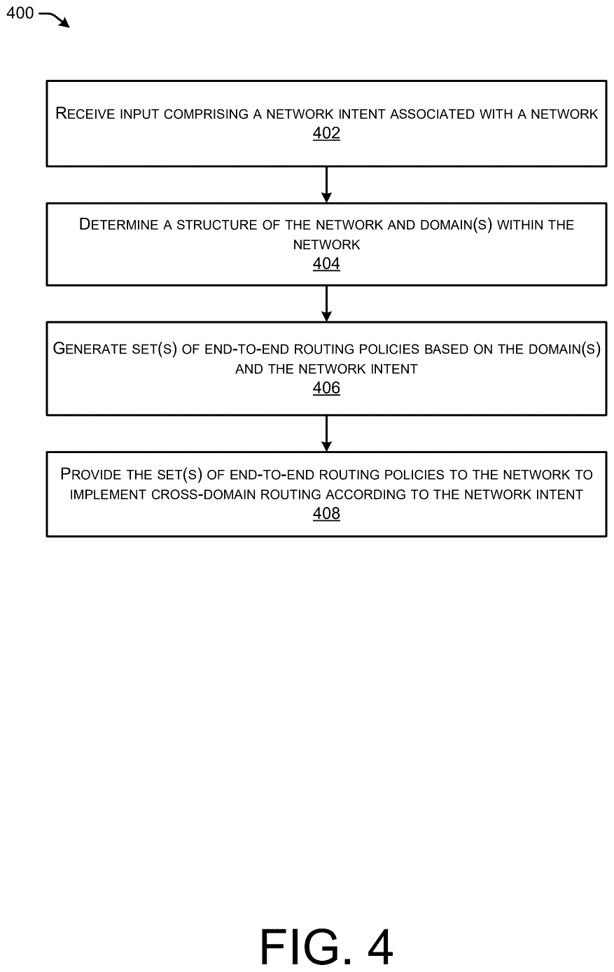

FIG. 4 illustrates a flow diagram of an example system 400 for automatically generating a global policy based on a network intent, in accordance with the techniques described in FIGS. 1-3. In some instances, one or more of the steps of system 400 may be performed by one or more devices (e.g., global controller 104, network device(s) 130, etc.) that include one or more processors and one or more non-transitory computer-readable media storing computer-executable instructions that, when executed by the one or more processors, cause the one or more processors to perform operations of system 400. In some examples, the system 400 may be performed by a global controller 104 or entity 102.

At 402, the system may receive input comprising a network intent associated with a network. For instance, a central entity, such as entity 102, may receive the input from a computing device of a user. The user may correspond to a network administrator. The computing device may correspond to an administrator device 120. In some examples, the the network intent comprises one or more of indications of sets of users, data types, quality of service, a priority associated with one or more of the users, a priority of one or more of the data types, and behavior associated with a policy type. In some examples, the network corresponds to an enterprise network 118.

At 404, the system may determine a structure of the network and domain(s) within the network. For instance, the system may automatically determine the structure (e.g., topology) of the network in response to receiving the network intent. The system may further determine which domain(s) are included in the topology. In some examples, determining the structure of the network and the one or more domains comprises: determining a number of domains associated with the network; and determining a topology of the network, the topology including: a number of network devices; a type of each the network devices, the type of network devices including one or more of a switch, a router, an access point, and a wireless controller; capabilities of each of the network devices; and a location associated with each of the network devices within the network. In some examples, the system may determine the structure and domain(s) using one or more of the policy module 110 and/or analytics module 108.

At 406, the system may generate set(s) of end-to-end routing policies based on the domain(s) and the network intent. In some examples, the set(s) of end-to-end routing policies correspond to a global policy, where each set of routing policies are associated with a different domain.

In some examples, the one or more domains comprises a first domain and a second domain, wherein generating the one or more sets of end-to-end policies comprises: defining, for the first domain, a first set of policy definitions associated with routing traffic through the first domain and between the first domain and the second domain in accordance with the network intent; and defining, for the second domain, a second set of policy definitions associated with routing traffic through the second domain and between the first domain and the second domain in accordance with the network intent. In some examples, the first set of policy definitions is based on a first domain type of the first domain and the second set of policy definitions is based on a second domain type of the second domain, the first domain and the second domain comprising different domain types. In some examples, the first domain comprises one of a wide area network (WAN), a wireless network, a campus network, a local area network (LAN), a campus LAN, a software defined (SD)-LAN, a SD-WAN, a cloud network, or a data center network.

At 408, the system may provide the set(s) of end-to-end routing policies to the network for implementing cross-domain routing according to the network intent. For instance, the system may push the global policy to the controller(s) of the enterprise network. The controller(s) and/or the system may push the portion(s) of the policies to various device(s) within each respective domain for enforcement. For instance, a controller of the enterprise network may configure access point(s), switch(es), router(s), etc. of a particular domain or network (e.g., LAN, WAN, etc.) according to the global policy.

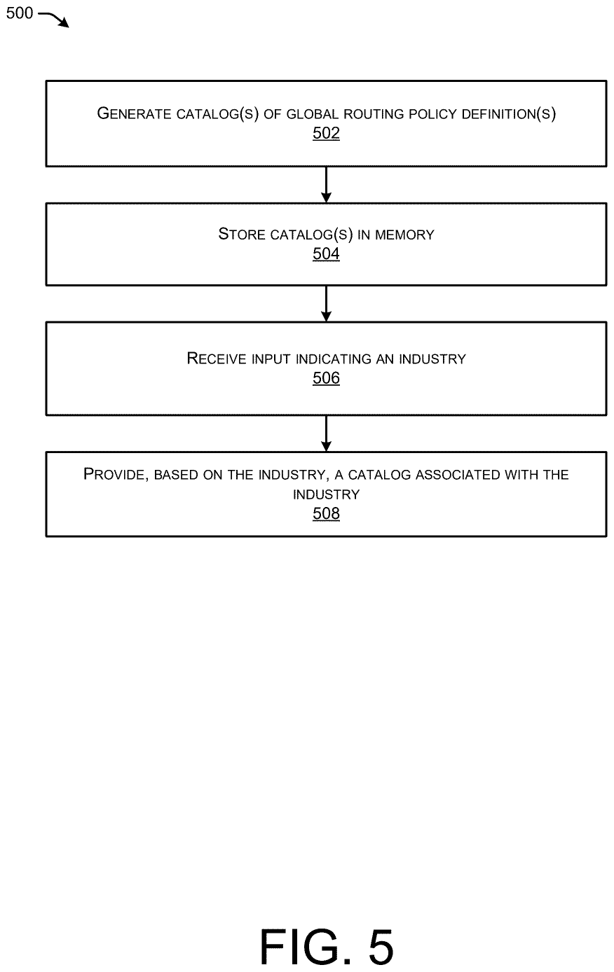

FIG. 5 illustrates a flow diagram of an example system 500 for generating and providing catalog(s) of global policies based on industry verticals, in accordance with the techniques described in FIGS. 1-4. In some instances, one or more of the steps of system 500 may be performed by one or more devices (e.g., entity 102, global controller 104, catalog system 112, network device(s) 130, etc.) that include one or more processors and one or more non-transitory computer-readable media storing computer-executable instructions that, when executed by the one or more processors, cause the one or more processors to perform operations of system 500.

At 502, the system may generate catalog(s) of global routing policy definition(s). For instance, the global routing policy definition(s) may include set(s) of pre-defined end-to-end routing policies for a particular industry. Example industries may include a hospital, business, manufacturing, retail, etc.

In some examples, generating the one or more catalogs comprises: determining, based on data associated with a plurality of users, a vertical construct of a first industry; determining, based on the data, a first domain included in the vertical construct; determining, based on the data, one or more policies utilized by a first set of the plurality of users of the first domain; determining, based on the data, one or more features associated with the one or more policies that are used by at least a threshold number of users of the plurality of users; generating a first set of pre-defined global routing policy definitions for the second domain; and generating, a first catalog for the first industry, the first catalog comprising a network map of the vertical construct, an indication of the first domain, and the first set of pre-defined global routing policy definitions.

In some examples, the system may determine, based on the data, a second domain included in the vertical construct; determine, based on the data, one or more second policies utilized by users of the second domain; determine, based on the data, one or more second features of the one or more second policies that are used by at least a threshold number of users of the users; and generate a second set of pre-defined global routing policy definitions for the second domain, wherein the first catalog further comprises the second set of pre-defined global routing policy definitions of the second domain.

At 504, the system may store catalog(s) in memory. For instance, the system may store the catalog(s) in memory of a catalog system, an entity, servers, or any other suitable memory. In some examples, the catalog(s) may be accessed by one or more controllers of a network of a user. For instance, a controller of a WAN within an enterprise network may download a portion of the catalog that includes the policies associated with routing traffic within the WAN and between the WAN and other domain(s).

At 506, the system may receive input indicating an industry. For instance, the system may receive an input 122 from a user of an enterprise network. The input may select a particular industry type (e.g., retail, hospital, business, etc.) associated with the user's enterprise network. In some examples, the input may be received by an entity 102 and/or a catalog system configured to interface with user device(s) (e.g., such as administrator device(s)).

At 508, the system may provide, based on the industry, a catalog associated with the industry for display. For instance, the system may output the selected catalog, such that the pre-defined set(s) of policies are displayed to the user. In some examples, the catalog may used as a pre-defined template for the user to deploy one or more of a Wireless, CAMPUS Switching infrastructure, WAN connectivity, Cloud Connectivity, and more with little input (e.g., a few clicks). In some examples, the user may customize the catalog. In other examples, the user may deploy (e.g., accept) the catalog as shown.

In some examples, the system may receive a second input indicating a modification to one or more of the global routing policy definitions. The system may generate, based on the second input, an updated set of global routing policy definitions (e.g., such as an updated or customized catalog). The system may provide the updated set (e.g., updated catalog) to a network controller associated with the user. For instance, the system may send or push the updated catalog to the enterprise network for implementation by the network devices.

In some examples, the system may receive a second input indicating an acceptance of the first set of global routing policy definitions (e.g., such as an acceptance of the catalog and/or an instruction to implement the catalog within an enterprise network). In this example, the system may program the first set of global routing policy definitions on network devices of one or more domains of a network associated with the user.

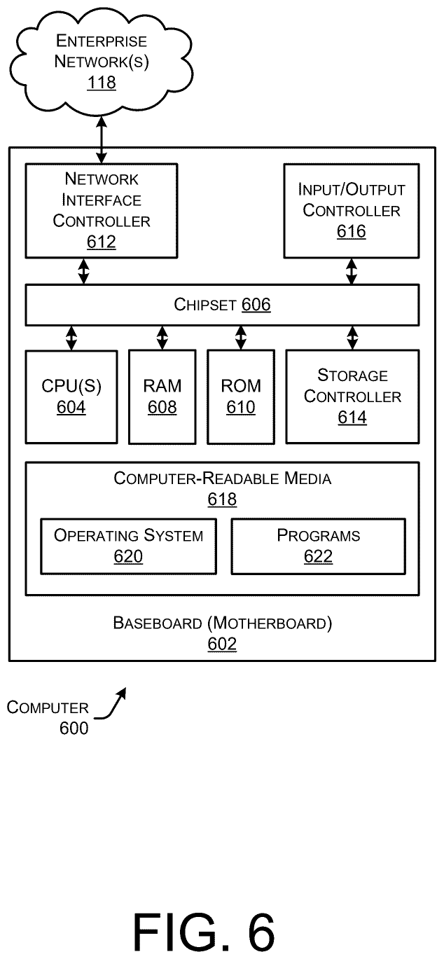

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer may, in some examples, correspond to an entity 102, catalog system 112, global controller 104, network device(s) 130, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as enterprise network(s) 118. The chipset 606 can include functionality for providing network connectivity through a NIC 612, such as a gigabit Ethernet adapter. The NIC 612 is capable of connecting the computer 600 to other computing devices over the enterprise network(s) 118. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the entity 102, catalog system 112, global controller 104, network device(s) 130, and/or any components included therein, may be supported by one or more devices similar to computer 600. Stated otherwise, some or all of the operations performed by the entity 102, catalog system 112, global controller 104, network device(s) 130,, and/or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of: entity 102, catalog system 112, global controller 104, network device(s) 130, and/or any other device. The computer 600 may include one or more hardware processors (processors, such as CPUs 604) configured to execute one or more stored instructions. The processor(s) may comprise one or more cores. Further, the computer 600 may include one or more network interfaces configured to provide communications between the computer 600 and other devices, such as the communications described herein as being performed by the global controller 104 and/or any other device. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure. For instance, the programs 622 may cause the computer 600 to perform techniques including receiving, by a central entity and from a computing device of a user, an input comprising a network intent of a network; determining, by the central entity and in response to the network intent, a structure of the network and one or more domains within the network; generating, by the central entity and based on the network intent and the structure, one or more sets of end-to-end routing policies for each respective domain of the one or more domains; and sending the one or more sets of end-to-end routing policies to one or more network devices of the network to enable the one or more network devices to implement cross-domain routing according to the network intent.

The programs 622 may also cause the computer 600 to perform techniques including generating, for one or more vertical constructs of one or more industry topologies, one or more catalogs including respective sets of global routing policy definitions; storing, in memory associated with a global entity, the respective sets of global routing policies in associated with a respective industry topology; receiving an input associated with a user, the input including an indication of a first industry; and providing, based on the first industry, a first catalog comprising a first set of global routing policy definitions for display.

In this way, the computer 600 can enable a catalog feature to automatically create policy (including VRF requirements), which may be used as a pre-defined template for a customer to deploy a Wireless, CAMPUS Switching infrastructure, WAN connectivity, Cloud Connectivity all with few clicks and thereby enabling simpler IT workflows for customers. Moreover, the computer 600 can utilize network intent to automatically identify a network topology of a customer, automatically generate a global policy based on the network intent, and implement the global policy across the enterprise network to provide consistent and harmonious enforcement across domains and provide a consistent user experience. By utilizing context and group tags that indicate the network intent, the computer 600 may stitch information together across different domains without a customer having to go into each controller of each domain and manually configure the policies. Accordingly, the techniques can streamline and simplify cross domain routing within enterprise networks.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method of generating global end-to-end routing policies, comprising:
receiving, by a central entity and from a computing device of a user, an input comprising a network intent of a network;
determining, by the central entity and in response to the network intent, a structure of the network, the structure including one or more domains;
generating, by the central entity and based on the network intent and the structure, one or more sets of end-to-end routing policies for each respective domain of the one or more domains; and
sending the one or more sets of end-to-end routing policies to one or more network devices of the network to enable the one or more network devices to implement cross-domain routing according to the network intent.

2. The method of claim 1, wherein the network intent comprises one or more of indications of sets of users, data types, quality of service, a priority associated with one or more users, a priority of one or more of the data types, and behavior associated with a policy type.

3. The method of claim 1, wherein determining the structure of the network and the one or more domains comprises:
determining a number of domains associated with the network; and
determining a topology of the network, the topology including:
a number of network devices;
a type of each network device, the type of the network device including one or more of a switch, a router, an access point, and a wireless controller;
capabilities of the network devices; and
a location associated with the network devices within the network.

4. The method of claim 1, wherein the one or more domains comprises a first domain and a second domain, wherein generating the one or more sets of end-to-end routing policies comprises:
defining, for the first domain, a first set of policy definitions associated with routing traffic through the first domain and between the first domain and the second domain in accordance with the network intent; and
defining, for the second domain, a second set of policy definitions associated with routing the traffic through the second domain and between the first domain and the second domain in accordance with the network intent.

5. The method of claim 4, wherein the first set of policy definitions is based on a first domain type of the first domain and the second set of policy definitions is based on a second domain type of the second domain, the first domain and the second domain comprising different domain types.

6. The method of claim 4, wherein the first domain comprises one of a wide area network (WAN), a wireless network, a campus network, a local area network (LAN), a campus LAN, a software defined (SD)-LAN, a SD-WAN, a cloud network, or a data center network.

7. The method of claim 1, wherein the central entity is implemented by a software defined wide area network service provider.

8. A system comprising:
one or more processors; and
one or more computer-readable media storing instructions that, when executed by the one or more processors, cause the one or more processors to perform operations comprising:
receiving an input comprising a network intent of a network;
determining, based on the network intent, a structure of the network, the structure including one or more domains;
generating, based on the network intent and the structure, one or more sets of end-to-end routing policies for each respective domain of the one or more domains; and
sending the one or more sets of end-to-end routing policies to one or more network devices of the network to enable the one or more network devices to implement cross-domain routing according to the network intent.

9. The system of claim 8, wherein the network intent comprises one or more of indications of sets of users, data types, quality of service, a priority associated with one or more of users, a priority of one or more of the data types, and behavior associated with a policy type.

10. The system of claim 8, wherein determining the structure of the network comprises:
determining a number of domains associated with the network; and
determining a topology of the network, the topology including:
a number of network devices;
a type of each network devices, the type of network device including one or more of a switch, a router, an access point, and a wireless controller;
capabilities of the network devices; and
a location associated with the network devices within the network.

11. The system of claim 8, wherein the one or more domains comprises a first domain and a second domain, wherein generating the one or more sets of end-to-end routing policies further comprises:
defining, for the first domain, a first set of policy definitions associated with routing traffic through the first domain and between the first domain and the second domain in accordance with the network intent; and
defining, for the second domain, a second set of policy definitions associated with routing the traffic through the second domain and between the first domain and the second domain in accordance with the network intent.

12. The system of claim 11, wherein the first set of policy definitions is based on a first domain type of the first domain and the second set of policy definitions is based on a second domain type of the second domain, the first domain and the second domain comprising different domain types.

13. The system of claim 11, wherein the first domain comprises one of a wide area network (WAN), a wireless network, a campus network, a local area network (LAN), a campus LAN, a software defined (SD)-LAN, a SD-WAN, a cloud network, or a data center network.

14. The system of claim 8, further comprising a central entity implemented by a software defined wide area network service provider.

15. A method of providing catalogs of global end-to-end routing policies based on network vertical, comprising:
generating, for one or more vertical constructs of one or more industry topologies, one or more catalogs including respective sets of pre-defined global routing policy definitions;
storing, in memory associated with an entity, respective catalogs in association with respective industry topologies;
receiving an input associated with a user, the input including an indication of a first industry; and
providing, based on the first industry, a first catalog comprising first sets of pre-defined global routing policy definitions for display.

16. The method of claim 15, further comprising:
receiving a second input indicating a modification to at least one pre-defined global routing policy definition;
generating, based on the second input, an updated set of global routing policy definitions; and
providing the updated set to a network controller associated with the user.

17. The method of claim 15, further comprising:
receiving a second input indicating an acceptance of the first sets of pre-defined global routing policy definitions; and
programming the first sets of pre-defined global routing policy definitions on one or more network devices of one or more domains of the network.

18. The method of claim 15, wherein generating the one or more catalogs comprises:
determining, based on data associated with a plurality of users, a vertical construct of the first industry;
determining, based on the data, a first domain included in the vertical construct;
determining, based on the data, one or more policies utilized by a first set of the plurality of users of the first domain;
determining, based on the data, one or more features associated with the one or more policies that are used by at least a threshold number of users of the plurality of users;
generating a first set of pre-defined global routing policy definitions for the first domain; and
generating, the first catalog for the first industry, the first catalog comprising a network map of the vertical construct, an indication of the first domain, and the first set of pre-defined global routing policy definitions.

19. The method of claim 18, wherein the plurality of users are associated with a plurality of tenants of a service provider, the plurality of tenants being within the first industry.

20. The method of claim 18, further comprising:
determining, based on the data, a second domain included in the vertical construct;
determining, based on the data, one or more second policies utilized by users of the second domain;
determining, based on the data, one or more second features of the one or more second policies that are used by at least a threshold number of users of the users; and
generating a second set of pre-defined global routing policy definitions for the second domain, wherein the first catalog further comprises the second set of pre-defined global routing policy definitions.
